(19) United States
(12) Patent Application Publication
(10) Pub. No.: US 2025/0297382 A1
(43) Pub. Date: Sep. 25, 2025

(54) ELECTROCATALYST AND METHOD FOR MANUFACTURING THE SAME

(71) Applicant: NATIONAL TSING HUA UNIVERSITY, Hsinchu City (TW)

(72) Inventors: Ya-Chu YANG, Hsinchu City (TW); Serhii MAKOVETSKYI, Hsinchu City (TW); I-Ching HSU, Hsinchu City (TW); Chun-Chi WANG, Hsinchu City (TW); Wei-Yuan ZHENG, Hsinchu City (TW); Pei-Yu WEI, Hsinchu City (TW); Fu-Te TSAI, Hsinchu City (TW); Wen-Feng LIAW, Hsinchu City (TW)

(21) Appl. No.: 18/749,943

(22) Filed: Jun. 21, 2024

(30) Foreign Application Priority Data
Mar. 22, 2024 (TW) 113110669

(51) Int. Cl. C25B 11/031; C25B 11/061; C25B 11/075; C25B 11/091

(52) U.S. Cl. CPC C25B 11/031; C25B 11/061; C25B 11/075; C25B 11/091

(57) ABSTRACT

An electrocatalyst and a manufacturing method thereof are provided. The electrocatalyst is a cathode electrocatalyst or an anode elctrocatalyst, wherein the cathode electrocatalyst comprises: a metal carrier; and a cathode electrocatalyst material disposed on the metal carrier; wherein the cathode electrocatalyst material comprises molybdenum, cobalt, nickel and nitrogen and further comprises one of aluminum and gallium.

### CROSS-REFERENCE TO RELATED APPLICATIONS

This application claims the benefits of the Taiwan Patent Application Serial Number 113110669, filed on Mar. 22, 2024, the subject matter of which is incorporated herein by reference.

### BACKGROUND OF THE INVENTION

### Field

The present invention relates to electrocatalysts and methods for manufacturing the same. More specifically, the present invention relates to ion-doped electrocatalysts and methods for manufacturing the same.

### Description of Related Art

In recent years, environmental issues have arisen, and scientists have developed a method of producing hydrogen through water splitting. Hydrogen is produced through the water splitting with characteristics of less pollution, rapid production, mild reaction conditions, and high productivity, which can be used as a low-pollution emerging energy source.

In the past, electrocatalytic water splitting mostly used electrocatalysts containing rare metals such as iridium (Ir) and platinum (Pt) for reactions. However, the high price of rare metals greatly limits mass production, which may affect the development of the electrocatalytic water splitting.

Therefore, it is desirable that the dependence on rare metals can be reduced through the development of catalysts.

### SUMMARY OF THE INVENTION

The present invention provides electrocatalysts and methods for manufacturing the same. More specifically, the present invention provides a cathode electrocatalyst and a method for manufacturing the same, as well as an anode electrocatalyst and a method for manufacturing the same. The cathode electrocatalyst and the anode electrocatalyst, respectively, comprise a metal carrier and an electrocatalyst material disposed on the metal carrier. Through the above design, the cathode electrocatalyst and the anode electrocatalyst can show good electrocatalytic efficiency without using rare metals, which can reduce the dependence on rare metals. In addition, when the cathode electrocatalyst and anode electrocatalyst of the present invention are used for water splitting reaction, the reaction can be stably performed for up to 90 days.

The present invention provides a cathode electrocatalyst, which comprises: a metal carrier; and a cathode electrocatalyst material disposed on the metal carrier, wherein the cathode electrocatalyst material comprises molybdenum, cobalt, nickel and nitrogen and further comprises one of aluminum and gallium.

The present invention also provides a method for manufacturing a cathode electrocatalyst, which comprises the following steps:
(A) placing a first metal salt solution and a metal carrier in a reaction bottle to perform a hydrothermal reaction to obtain a first intermediate, wherein the first metal salt solution comprises molybdenum, cobalt and nickel;
(B) placing the first intermediate in a nitrogen gas atmosphere and performing a first calcination to obtain a second intermediate;
(C) adding the second intermediate into a second metal salt solution to obtain a third intermediate, wherein the second metal salt solution comprises aluminum or gallium; and
(D) placing the third intermediate in an ammonia atmosphere and performing a second calcination to obtain a cathode electrocatalyst, wherein the cathode electrocatalyst comprises the metal carrier and a cathode electrocatalyst material disposed on the metal carrier, and the cathode electrocatalyst material comprises molybdenum, cobalt, nickel and nitrogen and further comprises one of aluminum and gallium.

In the present invention, by doping the cathode electrocatalyst material with cations and anions, the hydrogen evolution reaction (HER) efficiency of the cathode electrocatalyst can be improved, which can be used in industrial mass production of hydrogen (H₂).

In the present invention, in the cathode electrocatalyst material, a molar ratio of molybdenum, cobalt and nickel may be (2-5):(1-3):(1-3), for example, may be 3.5:(1-3):(1-3), (2-5):2:(1-3) or (2-5):(1-3):2; but the present invention is not limited thereto. More specifically, in the cathode electrocatalyst material, the molar ratio of molybdenum, cobalt and nickel may be, for example, 1:1:1, 2:1:1, 3:1:1, 3:2:1, 3:1:2, or 3.5:2:2; but the present invention is not limited thereto. When the molar ratio of molybdenum, cobalt and nickel falls within the above range, the cathode electrocatalyst can have good catalytic efficiency.

In the present invention, the cathode electrocatalyst material is in a porous rod form, which may be arranged in an array on the metal carrier. Thus, the cathode electrocatalyst material may have a porous micro-rod array structure. The porous structure of the cathode electrocatalyst material is conducive to increasing the contact area between the electrolyte and the electrode and increasing the reaction rate. In addition, the porous structure also facilitates the separation of bubbles from the electrode surface, which can reduce the reduction of electrode reaction area caused by the gas generated during the reaction. The “array” refers to, for example, the rods of the cathode electrocatalyst material arranged in an upright manner on the metal carrier. In the present invention, the cathode electrocatalyst material may have a width ranging from 500 nm to 3000 nm. More specifically, the rods of the cathode electrocatalyst material may have the width ranging from 500 nm to 3000 nm, for example, 800 nm to 3000 nm, 800 nm to 2500 nm, 800 nm to 2000 nm, 1000 nm to 3000 nm, 1000 nm to 2500 nm or 1000 nm to 2000 nm; but the present invention is not limited thereto.

In the present invention, the cathode electrocatalyst material may comprise a first portion and a second portion doped in the first portion, wherein the first portion comprises molybdenum, cobalt, nickel and nitrogen, and the second portion comprises one of aluminum and gallium. The first portion may be in a porous rod form, and the second portion may be, for example, particles of aluminum oxide or gallium oxide. In one embodiment of the present invention, the porous rods of the first portion may have widths ranging from 500 nm to 3000 nm, for example, 800 nm to 3000 nm, 800 nm to 2500 nm, 800 nm to 2000 nm, 1000 nm to 3000 nm, 1000 nm to 2500 nm or 1000 nm to 2000 nm; but the present invention is not limited thereto.

In the present invention, the metal carrier may comprise nickel foam, iron foam, molybdenum foam, copper foam, aluminum foam, titanium foam, iron nickel foam, nickel molybdenum foam, copper nickel foam, stainless steel foam or a combination thereof; but the present invention is not limited thereto. In one embodiment of the present invention, the metal carrier may be nickel foam (Ni foam). When a metal foam material is used as a metal carrier, the three-dimensional network structure of the metal foam material can provide good loading for the electrocatalyst, which can increase the contact area between the electrocatalyst and the electrolyte during the reaction. In addition, the metal foam material can also reduce the total weight of the electrode while maintaining reliability, and can be applied to micro or lightweight devices.

In the method of the present invention, the first metal salt solution and the second metal salt solution may, respectively, comprise a nitrate, a sulfate, a chloride, an acetate, an oxalate, a quaternary ammonium salt or a combination thereof. More specifically, the first metal salt solution may comprise, for example, MoO₂(NO₃)₂, Mo(SO₄)₃, molybdenum chloride (MoₓCl_{y}), Mo₂(CH₃COO)₄, (NH₄)₆Mo₇O₂₄, Co(NO₃)₂, CoSO₄, CoCl₂, Co(CH₃COO)₂, CoC₂O₄, Ni(NO₃)₂, NiSO₄, NiCl₂, Ni(CH₃COO)₂, NiC₂O₄ or a combination thereof; but the present invention is not limited thereto. The second metal salt solution may comprise, for example, Al(NO₃)₃, Al₂(SO₄)₃, AlCl₃, Al(CH₃COO)₃, Al₂(C₂O₄)₃, Ga(NO₃)₃, Ga₂(SO₄)₃, GaCl₃, Ga(CH₃COO)₃, Ga₂(C₂O₄)₃ or a combination thereof; but the present invention is not limited thereto. In one embodiment of the present invention, the first metal salt solution may comprise (NH₄)₆Mo₇O₂₄, Co(NO₃)₂ and Ni(NO₃)₂. In one embodiment of the present invention, the second metal salt solution may comprise Al(NO₃)₃ or GaCl₃.

In the method of the present invention, in the first metal salt solution, a molar ratio of molybdenum, cobalt and nickel is (2-5):(1-3):(1-3), for example, may be 3.5:(1-3):(1-3), (2-5):2:(1-3) or (2-5):(1-3):2; but the present invention is not limited thereto. More specifically, in the first metal salt solution, the molar ratio of molybdenum, cobalt and nickel may be, for example, 1:1:1, 2:1:1, 3:1:1, 3:2:1, 3:1:2 or 3.5:2:2; but the present invention is not limited thereto. In the method of the present invention, a concentration of the second metal salt solution may range from 0.1 M to 0.5 M, for example, may be 0.1 M, 0.2 M, 0.3 M, 0.4 M or 0.5 M; but the present invention is not limited thereto.

In the step (A) of the present invention, the hydrothermal reaction may comprise the following steps: (1) increasing the reaction temperature to 170-200° C. within 20-40 minutes; (2) maintaining the reaction at 170-200° C. for 5-8 hours; and (3) cooling the reaction to room temperature naturally. The first intermediate obtained through the above hydrothermal reaction may comprise an oxide of molybdenum, cobalt and nickel (MoCoNiOₓ) disposed on the metal carrier. The experimental parameters of the hydrothermal reaction will affect the shape and morphology of the electrocatalyst. Therefore, by designing the temperature of the hydrothermal reaction as a three-stage control, a metal oxide with a rod structure disposed on a metal carrier can be obtained in the present invention.

In the present invention, the first calcination may comprise the following steps: (4) injecting N₂ into a reactor at a flow rate of 0.3-0.8 L/min and heating the reactor to 700-1000° C. at a rate of 3-8° C./min; and (4) injecting 3-5% of H₂/N₂ mixed gas into the reactor at a flow rate of 0.1-0.3 L/min for 1-3 hours when the reactor is heated to 700-1000° C. The second intermediate obtained by the aforesaid first calcination may comprise molybdenum, cobalt and nickel, which are disposed on the metal carrier. The experimental parameters of the calcination will affect the reduction of metal oxides, and the above reaction conditions can ensure that the material only reacts in 3-5% of H₂/N₂ mixed gas for 1-3 hours. In addition, the obtained metals have the porous rod structure disposed on the metal carrier.

In the present invention, the step (C) may comprise immersing the second intermediate in the second metal salt solution in a direction perpendicular to the liquid surface of the second metal salt solution. Next, the second intermediate immersed in the second metal salt solution is taken out and dried to obtain the third intermediate.

In the present invention, the second calcination may comprise: placing the third intermediate in a reactor and reacting at 400° C.-500° C. for 1-5 hours in an ammonia atmosphere to obtain the cathode electrocatalyst of the present invention. Through high-temperature calcination, cations and anions can be doped into the electrocatalyst, thereby obtaining the electrocatalyst doped with cations and anions.

The present invention further provides an anode electrocatalyst, which comprises: a metal carrier; and an anode electrocatalytic material disposed on the metal carrier, wherein the anode electrocatalytic material comprises iron, cobalt, nickel and phosphorus.

The present invention also provides a method for manufacturing an anode electrocatalyst, comprising the following steps:
(a) placing a third metal salt solution and a metal carrier in a reaction bottle to perform a hydrothermal reaction to obtain a fourth intermediate, wherein the third metal salt solution comprises iron, cobalt and nickel; and
(b) placing the fourth intermediate in a nitrogen gas atmosphere and in the presence of a phosphorus-containing compound and performing a third calcination to obtain an anode electrocatalyst, wherein the anode electrocatalyst comprises the metal carrier and an anode electrocatalytic material disposed on the metal carrier, and the anode electrocatalytic material comprises iron, cobalt, nickel and phosphorus.

In the present invention, by doping the anode electrocatalytic material with phosphorus, the oxygen evolution reaction (OER) efficiency of the anode electrocatalyst can be improved, so that it can be applied to industrial mass production.

In the present invention, in the anode electrocatalytic material, the molar ratio of iron, cobalt and nickel may be 1:(1-3):1, for example, may be 1:1:1, 1:1.5:1, 1:2:1 or 1:3:1; but the present invention is not limited thereto. When the content of cobalt is increased, the anode electrocatalyst may have better electrocatalytic efficiency.

In the present invention, the anode electrocatalytic material is in a flake form directly grown on the metal carrier. More specifically, the anode electrocatalytic material may have two morphologies, including the nanoplate structure in the bottom layer and the sphere structure formed by nanoplates in the upper layer.

In the present invention, the metal carrier of the anode electrocatalyst and the metal carrier of the cathode electrocatalyst may be the same or different. The metal carrier may be the same as described above and is not described again here. In one embodiment of the present invention, the metal carrier of the anode electrocatalyst may be nickel foam.

In the method of the present invention, the third metal salt solution comprises a nitrate, a sulfate, a chloride, an acetate, an oxalate, a quaternary ammonium salt or a combination thereof. More specifically, the third metal salt solution may comprise, for example, Fe(NO₃)₃, Fe(NO₃)₂, Fe₂(SO₄)₃, FeSO₄, FeCl₃, FeCl₂, Fe(CH₃COO)₃, Fe(CH₃COO)₂, Fe₂(C₂O₄)₃, FeC₂O₄, Co(NO₃)₂, CoSO₄, CoCl₂, Co(CH₃COO)₂, CoC₂O₄, Ni(NO₃)₂, NiSO₄, NiCl₂, Ni(CH₃COO)₂, NiC₂O₄ or a combination thereof; but the present invention is not limited thereto. In one embodiment of the present invention, the third metal salt solution may comprise FeSO₄, CoSO₄ and NiSO₄.

In the method of the present invention, in the third metal salt solution, the molar ratio of iron, cobalt and nickel may be 1:(1-3):1, for example, may be 1:1:1, 1:1.5:1, 1:2:1 or 1:3:1; but the present invention is not limited thereto.

In the method of the present invention, the phosphorus-containing compound may comprise phosphate, phosphoric acid, phosphorus anion or a combination thereof, for example, may be H₃PO₄, H₃PO₃, H₃PO₂, (NH₄)₃PO₄, NH₄H₂PO₄, (NH₄)₂HPO₄, (NH₄)₃PO₃, (NH₄)₂HPO₃, NH₄H₂PO₃, NH₄)₃PO₂, (NH₄)₂HPO₂, NH₄H₂PO₂, Na₃PO₄, Na₂HPO₃, NaH₂PO₂, K₃PO₄, KH₂PO₃, KH₂PO₂ or a combination thereof; but the present invention is not limited thereto. In one embodiment of the present invention, the phosphorus-containing compound may be NaH₂PO₂.

In the step (a) of the present invention, the hydrothermal reaction may comprise: reacting at 100-150° C. for 2-6 hours. The fourth intermediate obtained through the above hydrothermal reaction may comprise a hydroxide of iron, cobalt and nickel (FeCoNi(OH)ₓ) disposed on the metal carrier. The experimental parameters of the hydrothermal reaction may affect the morphology of the electrocatalyst. If the hydrothermal reaction is performed under the above conditions, a metal hydroxide with the flake structure disposed on the metal carrier can be obtained.

In the present invention, the third calcination comprises: placing the fourth intermediate and the phosphorus-containing compound in a reactor, injecting N₂ into the reactor at a flow rate of 0.3-0.8 L/min, heating the reactor to 200-500° C. at a rate of 3-8° C./min, and maintaining for 0.5-2 hours to obtain the anode electrocatalyst of the present invention. Through high-temperature calcination, anions can be doped into the electrocatalyst to obtain an anode electrocatalyst doped with anions.

Since the cathode electrocatalyst and the anode electrocatalyst of the present invention, respectively, have good electrocatalytic efficiency, in the electrocatalytic hydrogen production module composed of the electrocatalyst of the present invention, the membrane electrode assembly (MEA) can have stable voltage, and the water splitting reaction can last up to 90 days.

Other novel features of the disclosure will become more apparent from the following detailed description when taken in conjunction with the accompanying drawings.

### BRIEF DESCRIPTION OF DRAWINGS

FIG. 1 shows scanning electron microscope (SEM) images of MoCoNiOₓ@NF.

FIG. 2 shows SEM images of MoCoNi@NF.

FIG. 3(a) shows a SEM image of Al—MoCoNiN@NF.

FIG. 3(b) shows a SEM image of Ga—MoCoNiN@NF.

FIG. 4(a) to FIG. 4(c) show X-ray photoelectron spectroscopy (XPS) spectra of MoCoNiOₓ@NF.

FIG. 5(a) to FIG. 5(c) show XPS spectra of MoCoNi@NF.

FIG. 6(a) to FIG. 6(e) show XPS spectra of Al—MoCoNiN@NF.

FIG. 7 is a diagram showing linear sweep voltammetry (LSV) curves of electrocatalysts.

FIG. 8 is a diagram showing the turnover frequencies (TOFs) of electrocatalysts at different potentials when performing the hydrogen evolution reaction (HER).

FIG. 9 shows a SEM image of FeCoNi(OH)ₓ@NF.

FIG. 10(a) to FIG. 10(c) show XPS spectra of FeCoNi(OH)ₓ@NF.

FIG. 11 is a diagram showing LSV curves of FeCoNi(OH)ₓ with different ratios.

FIG. 12 shows SEM images of P—FeCoNi@NF.

FIG. 13(a) to FIG. 13(d) show XPS spectra of P—FeCoNi@NF.

### DETAILED DESCRIPTION OF THE INVENTION

The following is specific embodiments to illustrate the implementation of the present invention. The following specific examples are to be construed as illustrative only and not in any way limiting of the remainder disclosed in this specification. Those who are familiar with this technique can easily understand the other advantages and effects of the present invention from the content disclosed in the present specification. The present invention can also be implemented or applied by other different specific embodiments, and various details in the present specification can also be modified and changed according to different viewpoints and applications without departing from the spirit of the present disclosure.

In the present invention, the use of ordinal terms such as “first”, “second”, etc. are used to distinguish multiple materials or steps with the same name. They do not in themselves imply or represent any previous ordinal number for the material or step. It does not mean that there is a relationship between them in terms of rank, level, step sequence, or process sequence.

In the present invention, the terms, such as “about”, “substantially”, or “approximately”, are generally interpreted as within 10%, 5%, 3%, 2%, 1%, or 0.5% of a given value or range. Furthermore, when a value is “in a range from a first value to a second value” or “in a range between a first value and a second value”, the value can be the first value, the second value, or another value between the first value and the second value.

It should be noted that the technical solutions provided by different embodiments hereinafter may be replaced, combined or used in combination, so as to constitute another embodiment without violating the spirit of the present invention.

### Cathode Electrocatalyst

### Preparation of MoCoNiOₓ@NF

Three metal salts, (NH₄)₆Mo₇O₂₄·4H₂O (3 mmol, 3.7 g), Co(NO₃)₂·6H₂O (12 mmol, 3.5 g) and Ni(NO₃)₂·6H₂O (12 mmol, 3.5 g) were placed in a 500 mL round bottom bottle, and mixed and dissolved with 500 mL of deionized water. The mixed solution and nickel foam (5 cm×5 cm) were put into a Teflon cup, placed in the reactor, and tighten it for heating reaction in a closed system. The heating conditions were set to three stages: (1) heating to 180° C. in 30 minutes; (2) maintaining at 180° C. for 6 hours; and (3) naturally cooling to room temperature. After the reaction was completed, the nickel foam was taken out and washed with deionized water and ethanol three times, respectively. After dried naturally at room temperature, a MoCoNi three-metal oxide that appears dark purple on the surface of the nickel foam was obtained, which is defined as MoCoNiOₓ@NF.

### Preparation of MoCoNi@NF

The MoCoNiOₓ@NF synthesized in the previous steps was placed flatly on an alumina crucible and put into a high-temperature tubular furnace. After tightening the valve, a vacuum pump was used to evacuate the system in the quartz tube to less than 2×10⁻² torr and then backfill with nitrogen gas. The nitrogen gas flow rate was maintained at 0.5 L/min. The temperature in the furnace was raised to 800° C. at a rate of 5° C./min. When the temperature reached to 800° C., the nitrogen gas was changed into 5% H₂/N₂ mixed gas, and the mixed gas was maintained at a flow rate of 0.2 L/min for 2 hours for calcination. After the reaction time was over and the gas was switched to nitrogen gas, the reaction was naturally cooled to room temperature. The above reaction conditions can ensure that the material only reacted for 2 hours in the 5% H₂/N₂ mixed gas. After the calcination was completed, an intermediate with a black surface can be obtained, which is defined as MoCoNi@NF.

### Preparation of Al—MoCoNiN@NF and Ga—MoCoNiN@NF

A metal solution of 0.3 M Al(NO₃)₃ or 0.3 M GaCl₃ was prepared in a 200 mL reaction bottle. A reverse tweezers was used to pick up the MoCoNi@NF synthesized in the previous steps, and the MoCoNi@NF was immersed into the above metal solution (Al(NO₃)₃ or GaCl₃) in the direction perpendicular to the liquid surface. Then, the MoCoNi@NF immersed in the above metal solution was taken out and naturally dried overnight at room temperature. The dried material was placed flatly on an alumina crucible, and reacted with NH₃ gas in a high-temperature furnace for calcination at 450° C. for 3 hours to obtain a cation-doped electrocatalyst (the cathode electrocatalyst of the present invention), which is defined as Al—MoCoNiN@NF or Ga—MoCoNiN@NF.

### Preparation of MoCoNiN@NF

The MoCoNi@NF was placed flatly on the alumina crucible and put into the high-temperature tubular furnace. After tightening the valve, a vacuum pump was used to evacuate the system in the quartz tube to less than 2×10⁻² torr and then backfilled with nitrogen gas. The nitrogen gas flow rate was maintained at 0.5 L/min. The temperature in the furnace was raised to 450° C. at a rate of 5° C./min. When the temperature reached to 450° C., the nitrogen gas was changed into 95% NH₃ gas, and the gas was maintained at a flow rate of 0.2 L/min for 3 hours for calcination. After the reaction time was over and the gas was switched to nitrogen gas, the reaction was naturally cooled to room temperature. After the reaction was completed, the original gray-black MoCoNi@NF was transformed into MoCoNiN@NF.

### Scanning Electron Microscope (SEM) Characterization

SEM scans the surface of a sample through a tiny focused electron beam. The interaction between the electron beam and the sample will generate secondary electrons, auger electrons, and backscattered electrons. Since the escape depth of the secondary electrons is limited (only about 5˜10 nm), by detecting the number of escaped secondary electrons, a three-dimensional image of the material surface can be observed. The above synthesized samples were characterized by SEM. From the SEM images, the morphologies of MoCoNiOₓ@NF, MoCoNi@NF, Al—MoCoNiN@NF, and Ga—MoCoNiN@NF can be observed.

MoCoNiOₓ@NF was observed through SEM, and the results are shown in FIG. 1. It can be found from FIG. 1 that the electrocatalyst has a micro-rod form with a rod width of about 1-2 μm, and the rods are arranged on the nickel foam in an array.

MoCoNi@NF was observed through SEM, and the results are shown in FIG. 2. It can be found that micro-rod electrocatalyst has a porous appearance, and the rod width maintains about 1-2 μm. The electrocatalyst can be arranged on the nickel foam in the form of porous micro-rod arrays.

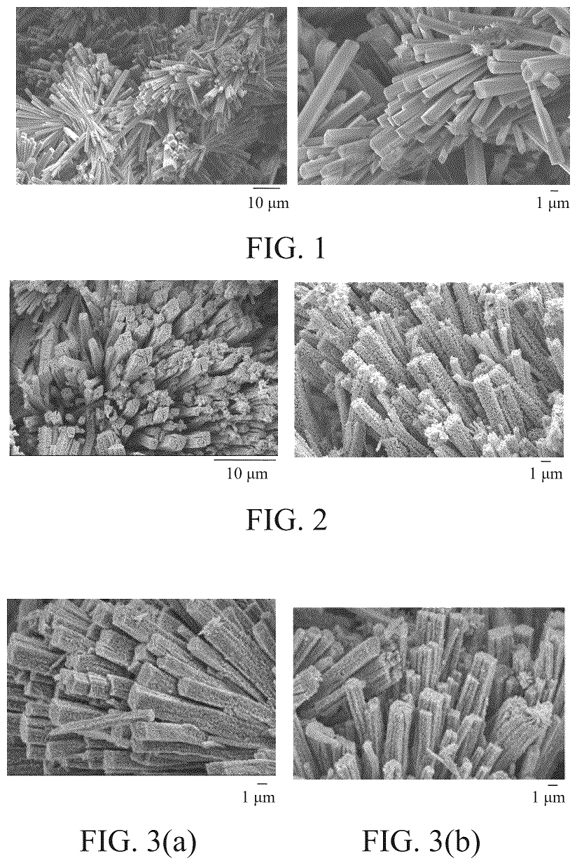

Al—MoCoNiN@NF and Ga—MoCoNiN@NF were observed through SEM, and the results are shown in FIG. 3(a) and FIG. 3(b). FIG. 3(a) shows a SEM image of Al—MoCoNiN@NF, and FIG. 3(b) shows a SEM image of Ga—MoCoNiN@NF. From FIG. 3(a) and FIG. 3(b), it can be found that the two electrocatalysts with cation doping still have the porous micro-rod array structure, and the electrocatalyst has small white bright spots on the rod top, which is speculated to be particles of oxides of Al or Ga.

### X-Ray Photoelectron Spectroscopy (XPS) Analysis

For the XPS analysis, an aluminum target was used as the excitation source of X-rays to excite the inner electrons (core levels) on the surface of the material to form photoelectrons. A hemispherical analyzer was used to measure the electron energy, angle and intensity of optoelectronics and auger electrons to conduct surface analysis such as qualitative, quantitative, and structural identification of the material surface. The test depth was 15 nm. The electron binding energy (E_{binding}) can be obtained through the incident X-ray energy (Eₚₕₒₜₒₙ), the photoelectron kinetic energy (E_{kinetic}) generated after X-ray irradiation on the sample surface, and the work function (ω) of the energy spectrometer. From the peak position and peak shape of the XPS spectrum, information such as the elemental composition, chemical state, and molecular structure of the sample surface can be obtained. The above synthesized samples were detected by XPS to analyze each sample.

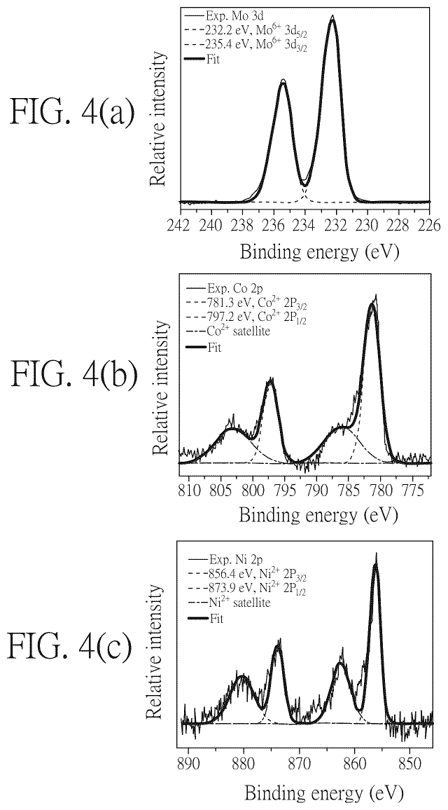

MoCoNiOₓ@NF was analyzed by XPS to detect Mo 3d, Co 2p and Ni 2p, respectively. The results are shown in FIG. 4(a) to FIG. 4(c). FIG. 4(a) is the XPS spectrum of Mo 3d, FIG. 4(b) is the XPS spectrum of Co 2p, and FIG. 4(c) is the XPS spectrum of Ni 2p. It is found from the experimental results that after MoCoNiOₓ@NF was synthesized by hydrothermal synthesis, no redox reaction occurs, and the oxidation valences of the three metals are maintained in high valence states (Mo⁶⁺, Co²⁺ and Ni²⁺).

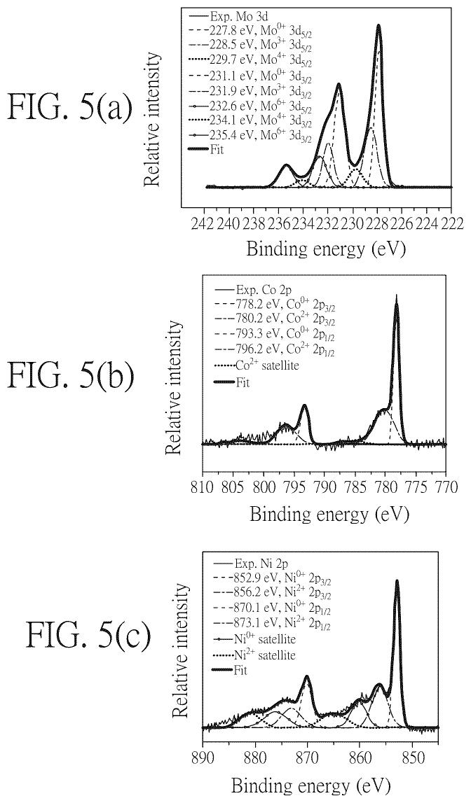

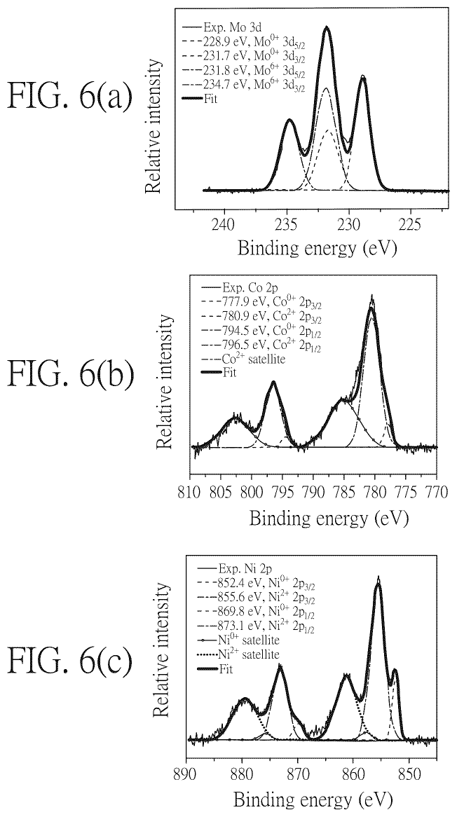

MoCoNi@NF was analyzed by XPS to detect Mo 3d, Co 2p and Ni 2p. The results are shown in FIG. 5(a) to FIG. 5(c). FIG. 5(a) is the XPS spectrum of Mo 3d, FIG. 5(b) is the XPS spectrum of Co 2p, and FIG. 5(c) is the XPS spectrum of Ni 2p. It is found from the experimental results that after calcination, the three metal elements of Mo, Co and Ni in MoCoNiOₓ@NF can be reduced. More specifically, as shown in FIG. 5(a), Mo in MoCoNi@NF may comprise high valence Mo⁶⁺ as well as reduced Mo⁰⁺, Mo³⁺ and Mo⁴⁺. As shown in FIG. 5(b), Co in MoCoNi@NF comprises Co²⁺ and reduced Co⁰⁺. As shown in FIG. 5(c), Ni in MoCoNi@NF comprises Ni²⁺ and reduced Ni⁰⁺. Thus, the XPS spectrum confirms that hydrogen has reducing ability and can effectively reduce oxides at high temperatures, thereby producing low-valence materials to form multi-alloy materials.

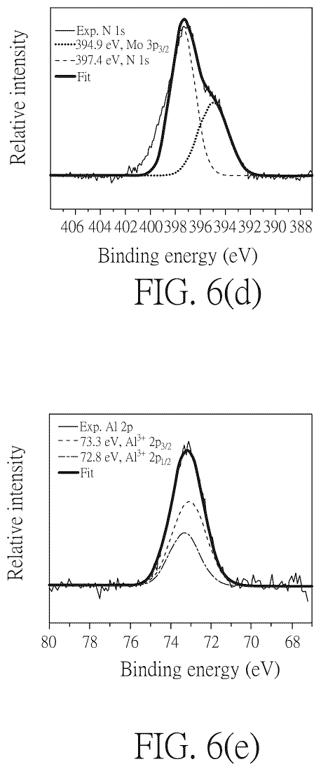

Al—MoCoNiN@NF was analyzed by XPS, and the results are shown in FIG. 6(a) to FIG. 6(e). FIG. 6(a) is the XPS spectrum of Mo 3d, FIG. 6(b) is the XPS spectrum of Co 2p, FIG. 6(c) is the XPS spectrum of Ni 2p, FIG. 6(d) is the XPS spectrum of N 1s, and FIG. 6(e) is the XPS spectrum of Al 2p. It is known from the experimental results that, in Al—MoCoNiN@NF, Mo comprises Mo⁶⁺ and Mo⁰⁺, Co comprises Co²⁺ and Co⁰⁺, Ni comprises Ni²⁺ and Ni⁰⁺, and N 1s shows the signal of metal nitride (M-N). The cation doping part can be inferred to be the signal of alumina (Al₂O₃), indicating that Al is doped in the porous micro-rod array in the form of oxide. This inference is consistent with the white bright spots observed by SEM.

### Catalytic Efficiency Evaluation

Electrocatalyst was used as the working electrode, and the reference electrode was an Hg/HgO electrode (E_{Hg/HgO}=0.118 V) as the counter electrode. At a constant temperature, the working electrode and the counter electrode were placed in 1 M NaOH (pH=14), and the efficiency of the electrocatalyst water splitting hydrogen evolution reaction (HER) was measured using linear sweep voltammetry (LSV) under a three-electrode system. The starting potential value of the reference electrode was used for correction, and the obtained experimental voltage (Eₑₓₚ) was converted into a standard hydrogen electrode (SHE) to evaluate the catalytic efficiency.

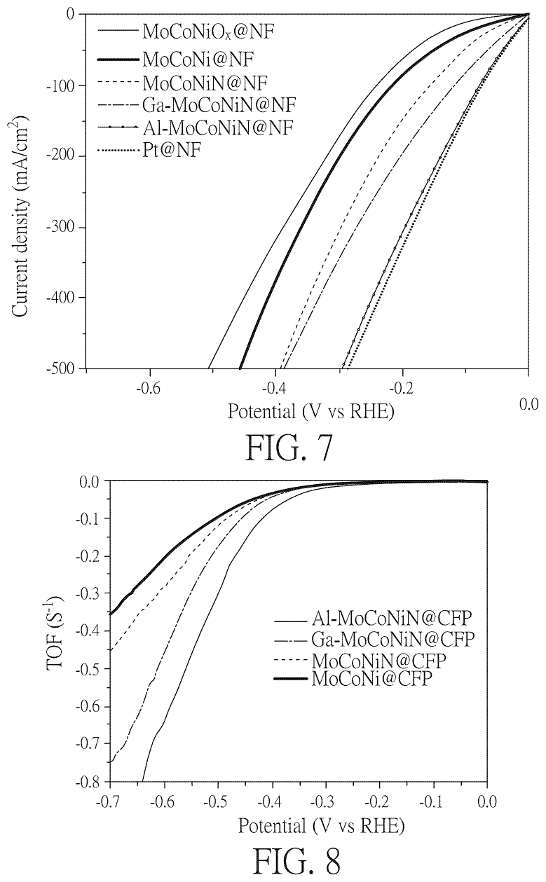

MoCoNiOₓ@NF, MoCoNi@NF, Al—MoCoNiN@NF, Ga—MoCoNiN@NF and MoCoNiN@NF synthesized in the previous steps and commercially available Pt@NF were used as working electrodes for HER. The overpotential voltage required reaching current densities of 10 mA/cm², 100 mA/cm² and 500 mA/cm² was measured. The results are shown in FIG. 7 and Table 1, wherein FIG. 7 is a diagram showing linear sweep voltammetry (LSV) curves of electrocatalysts.

It can be seen from the experimental results that using MoCoNiOₓ@NF as the working electrode, the current density of 10 mA/cm², 100 mA/cm² and 500 mA/cm² can be reached when the overpotential voltage was 92 mV, 242 mV and 510 mV, respectively. Using MoCoNi@NF as the working electrode, the current density of 10 mA/cm², 100 mA/cm² and 500 mA/cm² can be reached when the overpotential voltage was 53 mV, 218 mV and 457 mV, respectively. When anion-doped MoCoNiN@NF was used as the working electrode, the current density of 10 mA/cm², 100 mA/cm² and 500 mA/cm² can be reached when the overpotential voltage was 29 mV, 159 mV and 396 mV, respectively. When anion-doped and cation-doped Al—MoCoNiN@NF was used as the working electrode, the current density of 10 mA/cm², 100 mA/cm² and 500 mA/cm² can be reached when the overpotential voltage was 10 mV, 78 mV and 298 mV, respectively. When anion-doped and cation-doped Ga—MoCoNiN@NF was used as the working electrode, the current density of 10 mA/cm², 100 mA/cm² and 500 mA/cm² can be reached when the overpotential voltage was 17 mV, 119 mV and 390 mV, respectively.

In addition, according to the experimental results in FIG. 7 and Table 1, it can be found that when Al—MoCoNiN@NF was used as the working electrode, it exhibits excellent electrocatalytic efficiency and is comparable to the best electrocatalyst Pt@NF in HER.

TABLE 1

| | HER overpotential voltage (mV) | | |
|---|---|---|---|
| | η10 | η100 | η500 |
| Electrocatalyst | (mA/cm²) | (mA/cm²) | (mA/cm²) |
| MoCoNiOₓ@NF | 92 | 242 | 510 |
| MoCoNi@NF | 53 | 218 | 457 |
| MoCoNiN@NF | 29 | 159 | 396 |
| Ga—MoCoNiN@NF | 17 | 119 | 390 |
| Al—MoCoNiN@NF | 10 | 78 | 298 |
| Pt@NF | 10 | 75 | 291 |

### Hydrogen Production

The turnover frequency (TOF) of the electrocatalyst was used to measure the moles of hydrogen per time unit produced by one mole of the electrocatalyst active site at a constant temperature and pressure when the HER was performed using the electrocatalyst. In this way, the intrinsic activity of the electrocatalyst can be known.

Carbon fiber paper was used as the carrier of the electrode, and the powder of each electrocatalyst was dropped on the carbon fiber paper. The obtained electrocatalysts were, respectively, defined as MoCoNi@CFP, MoCoNiN@CFP, Al—MoCoNiN@CFP and Ga—MoCoNiN@CFP, respectively. The loading amount of each electrocatalyst was controlled to 0.1 mg/cm². Linear sweep voltammetry (LSV) was performed in alkaline electrolyte (1 M NaOH) with a scan potential window of −0.9 V to −1.8 V. The TOF value of the electrocatalyst was calculated through the electrochemical formula (I) to evaluate the intrinsic activity efficiency of each sample when performing HER using each electrocatalyst.

$$T O F ( {s}^{- 1} ) = \frac{j \times S}{z \times F \times n} = \frac{j \times 0.5}{2 \times 96485 \times {n}_{total}} \qquad ( I )$$

Wherein, j=current density;
S=surface area of the electrocatalyst=0.5 cm²;
z=number of electrons transferred when generating hydrogen gas;
F=Faraday's constant; and
n=moles of the active substance=nₜₒₜₐₗ=n_{Mo}+n_{Co}+n_{Ni}.

After calculation, the TOF values of each electrocatalyst at different potentials when performing HER in an alkaline environment (1 M NaOH) can be obtained, as shown in FIG. 8. From the results in FIG. 8, it can be found that at the potential of −0.4 V (relative to the reversible hydrogen electrode (v.s. RHE)), Al—MoCoNiN@CFP has the highest TOF value of 0.077 s⁻¹. If the amount of hydrogen produced by each electrocatalyst was calculated under standard temperature and pressure (STP) conditions, the results are shown in Table 2. At the potential of −0.4 V (v.s. RHE), the amount of hydrogen produced by MoCoNi@CFP can be 2096.64 L/h, the amount of hydrogen produced by MoCoNiN@CFP can be 2983.68 L/h, the amount of hydrogen produced by Al—MoCoNiN@CFP can be 6209.28 L/h, and the amount of hydrogen produced by Ga—MoCoNiN@CFP can be 3548.16 L/h. It can be found that under the same conditions, the electrocatalysts with cation and anion doping, Al—MoCoNiN@CFP and Ga—MoCoNiN@CFP, have good performance in hydrogen generation and can be used to produce hydrogen in large quantities in industry.

TABLE 2

| | Electrocatalyst (@CFP) | | | |
|---|---|---|---|---|
| | Al—MoCoNiN | Ga—MoCoNiN | MoCoNiN | MoCoNi |
| TOF(s⁻¹) | 0.077 | 0.044 | 0.037 | 0.025 |
| H₂(L/h) | 6209.28 | 3548.16 | 2983.68 | 2096.64 |

### Anode Electrocatalyst

### Preparation of FeCoNi(OH)ₓ@NF

FeSO₄·7H₂O (2.78 g, 10 mmol), CoSO₄·7H₂O (5.62 g, 20 mmol), NiSO₄·7H₂O (2.81 g, 10 mmol), urea (5.067 g, 84.45 mmol), NH₄F (2.5 g, 67.5 mmol) and 450 mL deionized water were placed in a reaction bottle, followed by stirring evenly with a stir bar. The mixed solution and nickel foam (5 cm×5 cm) were placed into a Teflon cup, and the hydrothermal synthesis reaction was performed at 120° C. for 4 hours. After the reaction was completed, an earthy yellow plate-like electrocatalyst material FeCoNi(OH)ₓ was obtained, which was grown directly on the nickel foam and was defined as FeCoNi(OH)ₓ@NF.

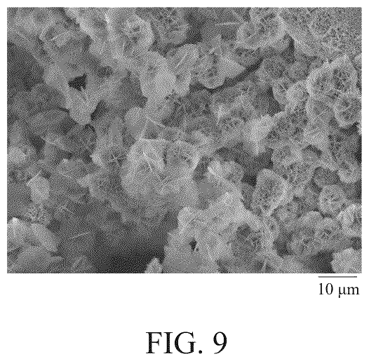

FeCoNi(OH)ₓ@NF was observed by SEM, and the results are shown in FIG. 9. From FIG. 9. It can be found that FeCoNi(OH)ₓ has two morphologies, including the nanoplate structure in the bottom layer and the sphere structure formed by nanoplates in the upper layer.

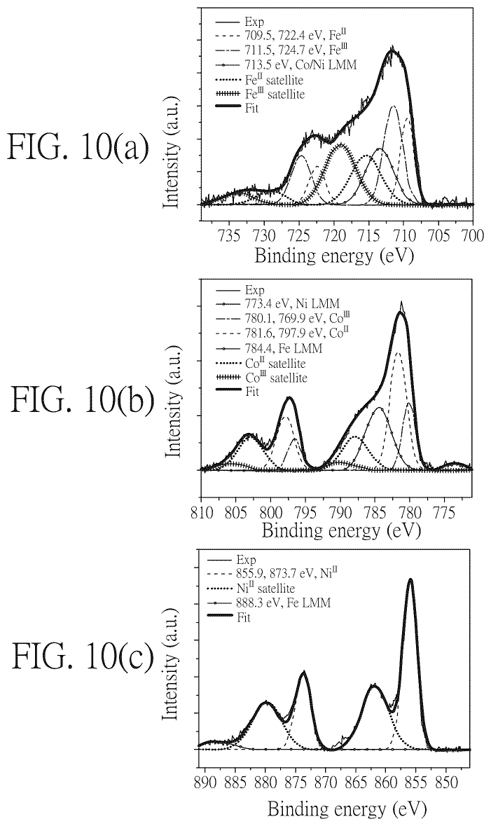

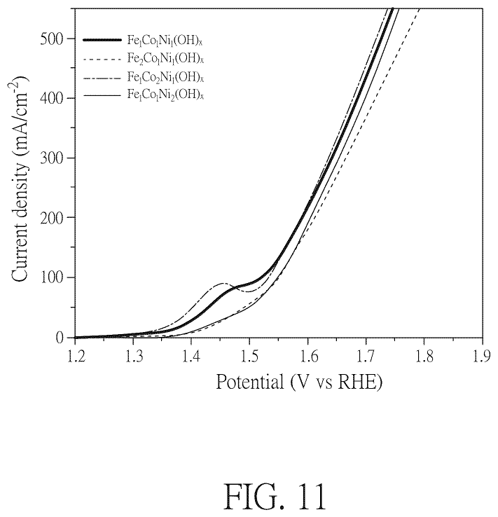

FeCoNi(OH)ₓ@NF was analyzed by XPS to detect Fe 2p, Co 2p and Ni 2p respectively. The results are shown in FIG. 10(a) to FIG. 10(c). FIG. 10(a) is the XPS spectrum of Fe 2p, FIG. 10(b) is the XPS spectrum of Co 2p, and FIG. 10(c) is the XPS spectrum of Ni 2p. As shown in FIG. 10(a), the peaks 2p_{3/2} and 2p_{1/2} of Fe²⁺ are located at 709.5 eV and 722.4 eV respectively, the area ratio is about 2:1, and the satellite peaks are located at 715.3 eV and 728.8 eV, respectively. The peaks 2p_{3/2} and 2p_{1/2} of Fe³⁺ are located at 711.5 eV and 724.7 eV, respectively, the area ratio is about 2:1, and the satellite peaks are located at 719.1 eV and 733.7 eV, respectively. The peak at 713.5 eV is the LMM signal of Co and Ni. As shown in FIG. 10(b), the peaks 2p_{3/2} and 2p_{1/2} of Co²⁺ are located at 781.6 eV and 797.9 eV respectively, the area ratio is about 2:1, and the satellite peaks are located at 787.8 eV and 802.9 eV, respectively. The peaks 2p_{3/2} and 2p_{1/2} of Co³⁺ are located at 780.1 eV and 796.5 eV, respectively, the area ratio is about 2:1, and the satellite peaks are located at 789.7 eV and 805.6 eV, respectively. The peak at 733.5 eV is the LMM signal of Ni, and the peak at 784.4 eV is the LMM signal of Fe. As shown in FIG. 10(c), the peaks 2p_{3/2} and 2p_{1/2} of Ni²⁺ are located at 855.9 eV and 873.7 eV, respectively, the area ratio is about 2:1, the satellite peaks are located at 861.77 eV and 879.7 eV respectively, and the peak at 888.3 eV is the LMM signal of Fe.

### Catalytic Efficiency Evaluation

A cyclic voltammetry (CV) was used as the power supply, and a two-compartment cell was used to conduct experiments under a three-electrode system. The cathode end and the anode end were separated by a semipermeable membrane. The electrolyte was 1 M KOH_{(aq)}. The reference electrode was an Hg/HgO electrode. The reference potential was E_{Hg/HgO}=0.118 V. The electrocatalytic efficiency was measured using linear sweep voltammetry (LSV) in cyclic voltammetry (CV). Under constant temperature and alkaline environment (1 M KOH, pH=14), the potential window of OER scanning was from 0.2 V to 1.1 V, and the covered current density was from 10 mA cm⁻² to 1 A cm⁻².

FeCoNi(OH)ₓ@NF was used as the working electrode and the reference electrode was used as the counter electrode. The electrocatalytic oxygen evolution reaction (OER) was performed to evaluate the catalytic efficiency.

By modifying the proportions of the three metal elements, Fe, Co and Ni in FeCoNi(OH)ₓ, the electrocatalytic efficiency performance when using FeCoNi(OH)ₓ in different proportions as the working electrode was measured. The results are shown in FIG. 11 and Table 3, wherein FIG. 11 is a diagram showing LSV curves of each electrocatalyst.

TABLE 3

OER overpotental voltage (mV)

| Electrocatalyst | η100 (mA/cm²) | η500 (mA/cm²) |
|---|---|---|
| Fe₁Co₁Ni₁(OH)ₓ@NF | 309 | 506 |
| Fe₂Co₁Ni₁(OH)ₓ@NF | 317 | 535 |
| Fe₁Co₂Ni₁(OH)ₓ@NF | 312 | 503 |
| Fe₁Co₁Ni₂(OH)ₓ@NF | 319 | 507 |

As shown in FIG. 11 and Table 3, in the case that Fe:Co:Ni was 1:1:1, when the current density reached 100 mA/cm² and 500 mA/cm², the overpotential voltage can be 309 mV and 506 mV respectively. In the case that Fe:Co:Ni was 2:1:1, when the current density reached 100 mA/cm² and 500 mA/cm², the overpotential voltage can be 317 mV and 535 mV respectively. In the case that Fe:Co:Ni was 1:1:2, when the current density reached 100 mA/cm² and 500 mA/cm², the overpotential voltage can be 319 mV and 507 mV, respectively. In the case that Fe:Co:Ni was 1:2:1, when the current density reached 100 mA/cm², the overpotential voltage can be 312 mV; and when the current density reached 500 mA/cm², the overpotential voltage can be 503 mV. From the above experimental results, it is found that when more Co is added, better catalytic efficiency will be achieved. When Fe:Co:Ni is 1:2:1, it can have good catalytic efficiency. Therefore, Fe:Co:Ni being 1:2:1 was used as the optimization condition for subsequent experiments.

### Preparation of P—FeCoNi@NF

The FeCoNi(OH)ₓ@NF synthesized in the aforementioned steps was placed flatly on an alumina crucible and put into a tubular high-temperature furnace. NaH₂PO₂·H₂O (5 g) was placed flatly on another alumina crucible, and placed on the front edge of the above-mentioned alumina crucible containing FeCoNi(OH)ₓ@NF. After tightening the valve, a vacuum pump was used to evacuate the system in the quartz tube to less than 2×10⁻² torr and then backfill with nitrogen gas. The nitrogen gas flow rate was maintained at 0.5 L/min. The temperature in the furnace was raised to 350° C. at a rate of 5° C./min for calcination for 1 hour. After the reaction time was over, the nitrogen atmosphere was maintained, and the reactor was naturally cooled to room temperature. A phosphorus-doped anode catalyst was synthesized, which is defined as P—FeCoNi@NF.

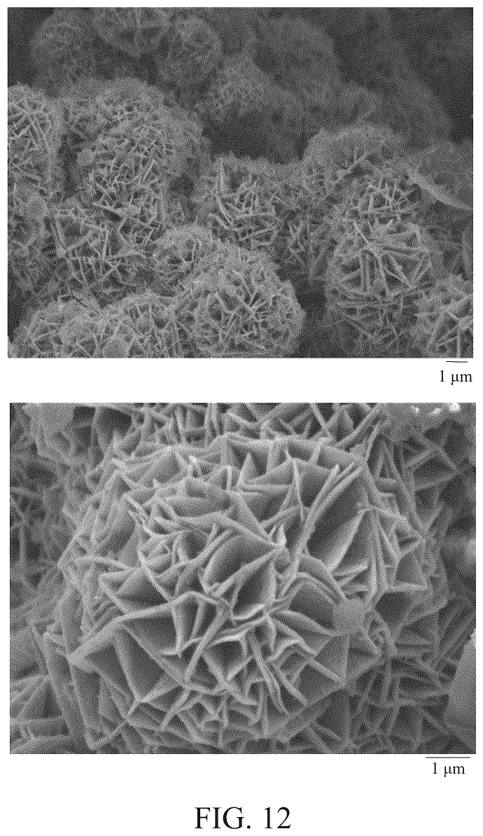

P—FeCoNi@NF was observed by SEM, and the results are shown in FIG. 12. From FIG. 12, it can be found that P—FeCoNi@NF maintains the sphere structure formed by nanoplates.

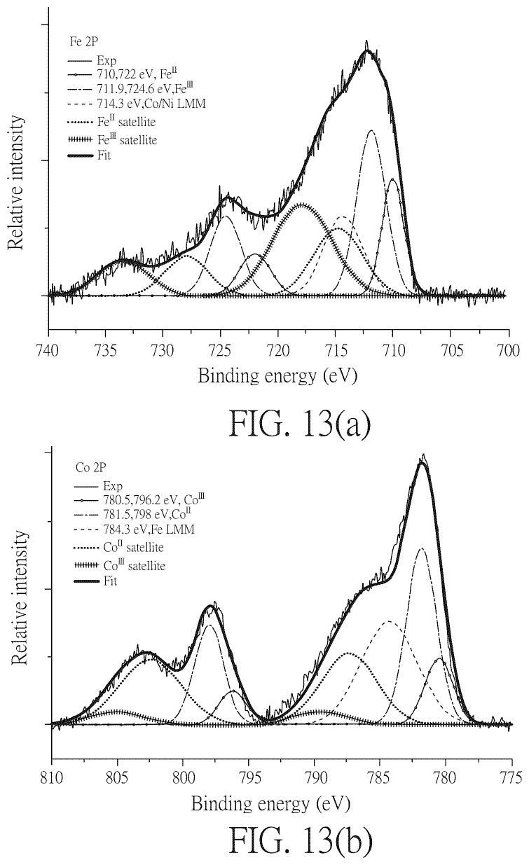

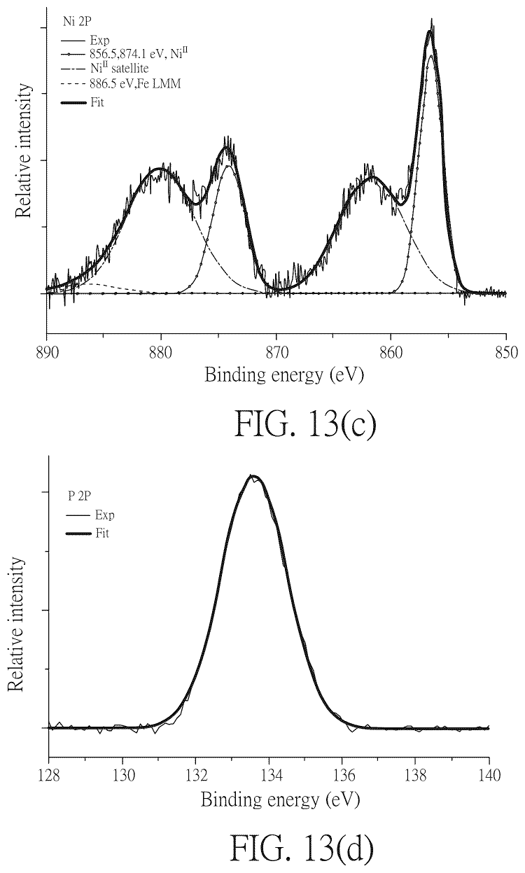

P—FeCoNi@NF was analyzed by XPS to detect Fe 2p, Co 2p, Ni 2p and P 2p, respectively. The results are shown in FIG. 13(a) to FIG. 13(d). FIG. 13(a) is the XPS spectrum of Fe 2p, FIG. 13(b) is the XPS spectrum of Co 2p, FIG. 13(c) is the XPS spectrum of Ni 2p, and FIG. 13(d) is the XPS spectrum of P 2p. As shown in FIG. 13(a), the peaks 2p_{3/2} and 2p_{1/2} of Fe²⁺ are located at 710 eV and 722 eV, respectively, the area ratio is about 2:1, the satellite peaks are located at 715.3 eV and 728.8 eV, respectively. The peaks 2p_{3/2} and 2p_{1/2} of Fe³⁺ are located at 711.9 eV and 724.6 eV respectively, the area ratio is about 2:1, and the satellite peaks are located at 718.5 eV and 733.7 eV, respectively. The peak at 714.3 eV is the LMM signal of Co and Ni. As shown in FIG. 13(b), the peaks 2p_{3/2} and 2p_{1/2} of Co²⁺ are located at 781.8 eV and 798 eV, respectively, the area ratio is about 2:1, the satellite peaks are located at 787.8 eV and 803 eV, respectively. The peaks 2p_{3/2} and 2p_{1/2} of Co³⁺ are located at 780.5 eV and 796.2 eV respectively, the area ratio is about 2:1, the satellite peaks are located at 789.7 eV and 805.6 eV, respectively. The peak at 784.3 eV is the LMM signal of Fe. As shown in 13(c), the peaks 2p_{3/2} and 2p_{1/2} of Ni²⁺ are located at 856.5 eV and 874.1 eV, respectively, the area ratio is about 2:1, and the satellite peaks are located at 861.8 eV and 879.7 eV, respectively. The peak at 886.5 eV is the LMM signal of Fe. As shown in FIG. 13(d), the peak of P 2p is located at 133.5 eV.

### Electrocatalytic Hydrogen Production Module

In the electrocatalytic water splitting hydrogen production module (the reaction area of the electrocatalyst is 25 cm², zero-gap AEM single cell), the cathode electrocatalyst Al—MoCoNiN@NF was used as the cathode, and the anode electrocatalyst P—FeCoNi@NF was used as the anode, and 1 M KOH was used as the electrolyte. The reaction was carried out at a fixed current density to test the stability of the electrocatalytic hydrogen production module.

Under the conditions of 35° C. and a fixed current of 12.5 A, the above-mentioned electrocatalytic water splitting hydrogen production module was tested for stability. Fresh 1 M KOH electrolyte was added at about 30 hours until the end of the test, and it was found that the electrocatalyst could carry out water splitting reactions for up to 90 days. At the beginning, the starting voltage of the module was 2.04 V. After activation for a period of time, the electrocatalyst showed better efficiency and the voltage dropped to 1.89 V. Then, as time passed, the voltage of the membrane electrode assembly (MEA) reached 1.99 V. It can be seen from this that without using rare metals, using the electrocatalyst of the present invention as an electrode can successfully carry out the water splitting reaction for up to 90 days, thereby reducing production costs and being beneficial to mass production.

The above specific examples are to be construed as illustrative only and not in any way limiting of the remainder of the disclosure.

Although the present disclosure has been explained in relation to its embodiment, it is to be understood that many other possible modifications and variations can be made without departing from the spirit and scope of the disclosure as hereinafter claimed.

1. A cathode electrocatalyst, comprising:
a metal carrier; and
a cathode electrocatalyst material disposed on the metal carrier,
wherein the cathode electrocatalyst material comprises molybdenum, cobalt, nickel and nitrogen, and further comprises one of aluminum and gallium.

2. The cathode electrocatalyst of claim 1, wherein a molar ratio of molybdenum, cobalt and nickel is (2-5):(1-3):(1-3) in the cathode electrocatalyst material.

3. The cathode electrocatalyst of claim 1, wherein the cathode electrocatalyst material is in a porous rod form.

4. The cathode electrocatalyst of claim 1, wherein the cathode electrocatalyst material comprises a first portion and a second portion doped in the first portion, wherein the first portion comprises molybdenum, cobalt, nickel and nitrogen, and the second portion comprises one of aluminum and gallium.

5. The cathode electrocatalyst of claim 1, wherein the cathode electrocatalyst material has a width ranging from 500 nm to 3000 nm.

6. The cathode electrocatalyst of claim 1, wherein the metal carrier comprises nickel foam, iron foam, molybdenum foam, copper foam, aluminum foam, titanium foam, iron nickel foam, nickel molybdenum foam, copper nickel foam, stainless steel foam or a combination thereof.

7. A method for manufacturing a cathode electrocatalyst, comprising the following steps:
(A) placing a first metal salt solution and a metal carrier in a reaction bottle to perform a hydrothermal reaction to obtain a first intermediate, wherein the first metal salt solution comprises molybdenum, cobalt and nickel;
(B) placing the first intermediate in a nitrogen gas atmosphere and performing a first calcination to obtain a second intermediate;
(C) adding the second intermediate into a second metal salt solution to obtain a third intermediate, wherein the second metal salt solution comprises aluminum or gallium; and
(D) placing the third intermediate in an ammonia atmosphere and performing a second calcination to obtain a cathode electrocatalyst, wherein the cathode electrocatalyst comprises the metal carrier and a cathode electrocatalyst material disposed on the metal carrier, and the cathode electrocatalyst material comprises molybdenum, cobalt, nickel and nitrogen and further comprises one of aluminum and gallium.

8. The method of claim 7, wherein the first metal salt solution and the second metal salt solution, respectively, comprise a nitrate, a sulfate, a chloride, an acetate, an oxalate, a quaternary ammonium salt or a combination thereof.

9. The method of claim 7, wherein a molar ratio of molybdenum, cobalt and nickel is (2-5):(1-3):(1-3) in the first metal salt solution.

10. The method of claim 7, wherein the metal carrier comprises nickel foam, iron foam, molybdenum foam, copper foam, aluminum foam, titanium foam, iron nickel foam, nickel molybdenum foam, copper nickel foam, stainless steel foam or a combination thereof.

11. The method of claim 7, wherein the first intermediate comprises an oxide of molybdenum, cobalt and nickel disposed on the metal carrier.

12. The method of claim 7, wherein the second intermediate comprises molybdenum, cobalt and nickel disposed on the metal carrier.

13. An anode electrocatalyst, comprising:
a metal carrier; and
an anode electrocatalytic material disposed on the metal carrier,
wherein the anode electrocatalytic material comprises iron, cobalt, nickel and phosphorus.

14. The anode electrocatalyst of claim 13, wherein a molar ratio of iron, cobalt and nickel is 1:(1-3):1 in the anode electrocatalytic material.

15. The anode electrocatalyst of claim 13, wherein the anode electrocatalytic material is in a flake form directly grown on the metal carrier.

16. The anode electrocatalyst of claim 13, wherein the metal carrier comprises nickel foam, iron foam, molybdenum foam, copper foam, aluminum foam, titanium foam, iron nickel foam, nickel molybdenum foam, copper nickel foam, stainless steel foam or a combination thereof.

17. A method for manufacturing an anode electrocatalyst, comprising the following steps:
(a) placing a third metal salt solution and a metal carrier in a reaction bottle to perform a hydrothermal reaction to obtain a fourth intermediate, wherein the third metal salt solution comprises iron, cobalt and nickel; and
(b) placing the fourth intermediate in a nitrogen gas atmosphere and in the presence of a phosphorus-containing compound and performing a third calcination to obtain an anode electrocatalyst, wherein the anode electrocatalyst comprises the metal carrier and an anode electrocatalytic material disposed on the metal carrier, and the anode electrocatalytic material comprises iron, cobalt, nickel and phosphorus.

18. The method of claim 17, wherein the third metal salt solution comprises a nitrate, a sulfate, a chloride, an acetate, an oxalate, a quaternary ammonium salt or a combination thereof.

19. The method of claim 17, wherein a molar ratio of iron, cobalt and nickel is 1:(1-3):1 in the third metal salt solution.

20. The method of claim 17, wherein the fourth intermediate comprises a hydroxide of iron, cobalt and nickel disposed on the metal carrier.
